(19) United States
(12) Patent Application Publication
(10) Pub. No.: US 2025/0111397 A1
(43) Pub. Date: Apr. 3, 2025

(54) DYNAMICALLY TARGETED NETWORK INVITATIONS

(71) Applicant: INTUIT INC., Mountain View, CA (US)

(72) Inventors: Hadar LACKRITZ, Tel-Aviv (IL); Natalie BAR ELIYAHU, Azor (IL); Omer WOSNER, Modi'in (IL)

(21) Appl. No.: 18/480,308

(22) Filed: Oct. 3, 2023

(51) Int. Cl. H04L 41/142; H04L 41/0893; H04L 43/0876

(52) U.S. Cl. CPC G06Q 30/0204; G06Q 50/01

(57) ABSTRACT

The present disclosure relates to dynamic targeting of network invitations. Embodiments include clustering, based on network usage data, a plurality of in-network entities into active network users and passive network users. Embodiments include generating, for each active in-network entity, a vector representation based on connections between the active in-network entity and one or more other entities. Embodiments include generating, for each out-of-network entity, a corresponding vector representation based on connections between the out-of-network entity and one or more in-network entities. Embodiments include determining, for each out-of-network, a probability that the out-of-network entity will join the network based on comparing the corresponding vector representation of the out-of-network entity to a vector that is determined based on the vector representation of each active in-network entity. Embodiments include selecting an out-of-network entity to invite to the network based on the probability that the out-of-network entity will join the network.

### INTRODUCTION

Aspects of the present disclosure relate to techniques for dynamically targeting network invitations to entities outside of a network through an iterative feedback loop by which a system automatically learns and improves.

### BACKGROUND

Every year millions of people, businesses, and organizations around the world use software applications for a wide variety of purposes. Often, users of a software application engage in various transactions via the software application with other users as well as with non-users. Users of a software application may be referred to as in-network entities, while non-users may be referred to as out-of-network entities.

Providers of software applications may wish to invite non-users to become users in order to grow a customer base and expand a network of users. However, it may be difficult to determine which non-users are likely to have interest in a particular software application, and generation and transmission of invitations may therefore be an inefficient process. For example, sending invitations to all known non-users may result in large numbers of ignored or rejected invitations, may unnecessarily consume large amounts of computing resources, and may also be impractical. Furthermore, attempts to automatically determine which non-users are likely to have interest in a software application using existing techniques, such as based on known attributes of the non-users, may be inaccurate or ineffective due to the relatively small amount of pertinent data about non-users that is generally available. While a static model may be constructed that allows for comparing attributes of non-users to attributes of users represented in the model, such a static model does not accurately represent the evolving behavior of users over time, and a missing signal during the training phase of such a static model will affect the accuracy of the model during its entire lifecycle. Furthermore, training a machine learning model such as a neural network or tree-based model using conventional techniques to predict non-users that are likely to accept an invitation to join a network generally requires large amounts of labeled training data in order to be effective, and generating such large amounts of labeled training data is time-consuming, expensive, and inefficient. Finally, determining whether non-users are likely to accept an invitation to join a network based on classification performed using predefined features is generally inaccurate, as these techniques are limited to those predefined features and assume that those are the primary factors affecting a non-user's decision of whether to accept an invitation to join the network.

What is needed is a solution for improved automated techniques for targeting of invitations to join a network to entities outside of the network.

### BRIEF SUMMARY

Certain embodiments provide a method for dynamic targeting of network invitations. In one embodiment, a method includes: clustering, based on network usage data, a plurality of in-network entities that are members of a network into a first cluster that represents active network users and a second cluster that represents passive network users; generating, for each in-network entity in the first cluster, a vector representation of the in-network entity based on connections between the in-network entity and one or more other entities; generating, for each out-of-network entity of a plurality of out-of-network entities that are not members of the network, a corresponding vector representation of the out-of-network entity based on connections between the out-of-network entity and one or more of the plurality of in-network entities; determining, for each out-of-network entity of the plurality of out-of-network entities, a probability that the out-of-network entity will join the network based on comparing the corresponding vector representation of the out-of-network entity to a vector that is determined based on the vector representation of each in-network entity in the first cluster; selecting an out-of-network entity of the plurality of out-of-network entities to invite to join the network based on the probability that the out-of-network entity will join the network; and inviting the out-of-network entity to join the network based on the selecting.

Other embodiments provide: an apparatus operable, configured, or otherwise adapted to perform the aforementioned method as well as those described elsewhere herein; a non-transitory, computer-readable media comprising instructions that, when executed by a processor of an apparatus, cause the apparatus to perform one or more of the aforementioned methods as well as those described elsewhere herein; a computer program product embodied on a computer-readable storage medium comprising code for performing one or more of the aforementioned methods as well as those described elsewhere herein; and an apparatus comprising means for performing one or more of the aforementioned methods as well as those described elsewhere herein. By way of example, an apparatus may comprise a processing system, a device with a processing system, or processing systems cooperating over one or more networks.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment for dynamically targeted network invitations.

FIG. 2 is an illustration of example aspects related to dynamically targeted network invitations.

FIG. 3 is an illustration of additional example aspects related to dynamically targeted network invitations.

FIG. 4 depicts example operations related to dynamically targeted network invitations.

FIGS. 5A and 5B depict example processing systems related to dynamically targeted network invitations.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to dynamically targeted network invitations through an interactive feedback loop by which targeting is iteratively improved.

Providers of software applications generally wish to increase the number of users in the software application's network of users. However, it is often difficult to determine which non-users are likely to have interest in a software application due to the relatively small amount of pertinent data that is generally available about non-users. Static models do not capture the evolving nature of user behavior over time. Furthermore, training a machine learning model such as a neural network or tree-based model using conventional techniques to predict non-users that are likely to accept an invitation to join a network generally requires large amounts of labeled training data, which is time-consuming, expensive, and inefficient to generate. In many cases, it may be impractical to generate the amounts of labeled training data needed in order to train such a model to perform at a sufficient level of accuracy for a specific software application. Additionally, relying only on predefined features in order to determine whether non-users are likely to accept invitations generally produces inaccurate results due to an over-reliance on those predefined features and an inaccurate assumption that those predefined features are the primary contributors to a non-user's decision of whether to accept an invitation to join the network. Embodiments of the present disclosure overcome these challenges by dynamically targeting network invitations to non-users through a particular machine learning process that is based on unique insights extracted from available electronic data about interactions among users and non-users, and that involves an “explore and exploit” feedback loop by which the process incrementally improves without the need for large amounts of labeled training data.

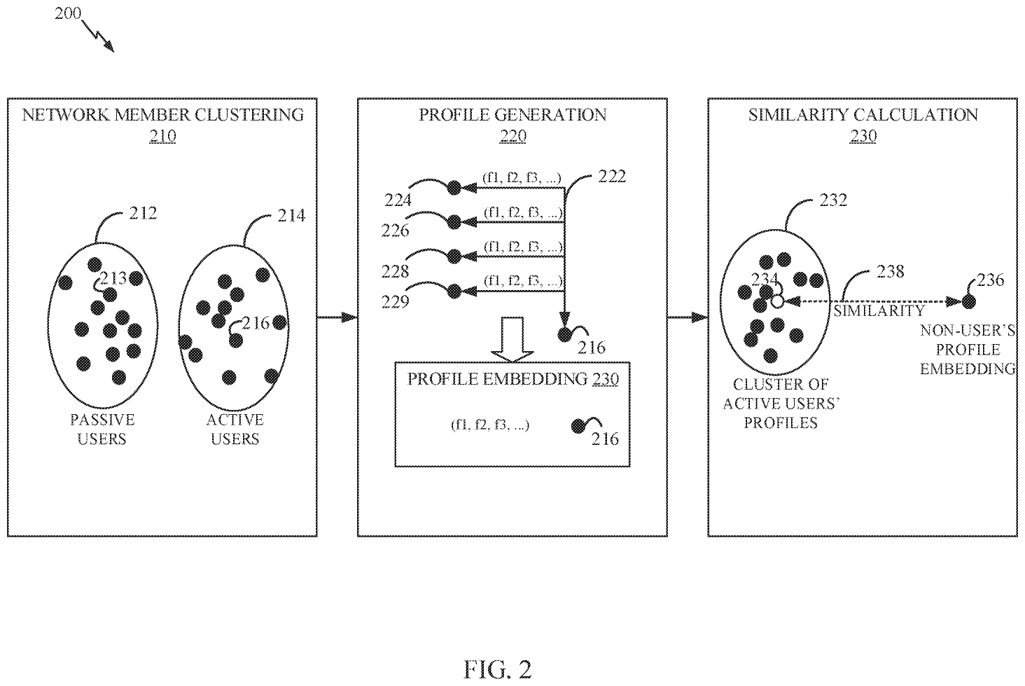

According to certain embodiments, users of a software application are clustered based on a variety of attributes related to a level of engagement with the software application in order to determine two clusters, including a first cluster representing users that are more active (e.g., “active users”) and users that are less active (e.g., “passive users”). For example, as explained in more detail below with respect to FIG. 2, the attributes used to cluster users into active users and passive users may include numbers of connections (e.g., between a given user and other users and/or non-users), numbers of requests sent (e.g., requests sent from a given user to other users and/or non-users to perform some action related to the application), numbers of approved requests, numbers of received requests, numbers of particular types of actions performed within the software application, and/or the like. If the software application is a financial services application, the attributes may also include, for example, numbers of bills sent within the network, numbers of invoices converted into bills, and/or the like. The cluster representing active users may be referred to as the “golden cluster,” as it represents users that are not only members of the network but are also actively engaged with the functionality provided by the network. The cluster representing passive users generally represents users that are members of the network but have not fully engaged with the functionality provided by the network, and therefore may be users that do not enjoy the benefits of the software application.

Profiles may then be generated for all users in the active user cluster, and profiles may also be generated for all non-users that are connected to users of the network (e.g., via interactions, such as transactions, indicated in electronic data available to the application). The process for generating a profile for a given entity (e.g., user or non-user) may involve determining all known connections between the entity and other entities (e.g., users or non-users), which may be based on available electronic records of transactions between the entity and the other entities. The known connections between an entity and other entities may be used to generate a profile for the entity, such as by aggregating data from the known connections. In one example, vectors representing the connections are generated, and the vectors are aggregated to produce a vector that represents the entity (e.g., the vector may be the profile of the entity). The attributes of a connection that are used to generate a vector representing the connection may include, for example, a number of interactions (e.g., payments) associated with the connection, amounts of transactions associated with the connection (e.g., amounts of money paid between the connected entities), frequency of interactions via the connection, whether certain features are enabled for the connection (e.g., automatic payment configuration), and/or the like.

Once profiles have been generated for each user in the active users cluster and for each non-user connected to one or more users, such as by aggregating connection vectors for each user or non-user, these profiles may be used to determine which non-users are likely to respond positively to an invitation to join the network. For example, the profile (e.g., vector) of a given non-user may be compared to a vector determined based on the profiles of all users in the active user cluster in order to determine whether the given non-user is likely to respond positively to an invitation to join the network. In one example, a center point of the profiles (vectors) of the users in the active user cluster is compared to the profile of the given non-user (e.g., using cosine similarity or another similarity measure) in order to determine how similar the given non-user is to the users in the active user cluster. The more similar the given non-user is to the users in the active user cluster, the more likely the given non-user is to respond positively to an invitation to join the network (e.g., because the given non-user is similar to users who are actively engaged with the functionality provided by the network). A similarity score representing a similarity between the profile of the given non-user and the vector (e.g., center point) determined based on the profiles of the users in the active user cluster may be used as a “prior probability” (e.g., meaning a probability unconfirmed by ground truth) that the given non-user will join the network by accepting an invitation.

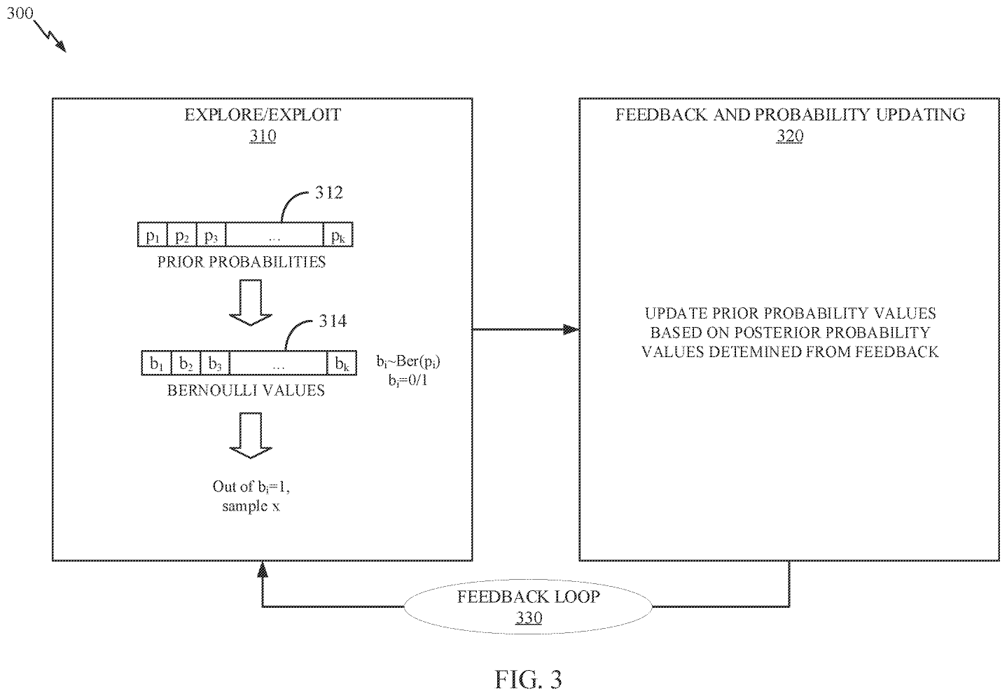

According to some embodiments, an “explore and exploit” process is used in order to iteratively improve the prior probabilities associated with each non-user based on an interactive feedback loop. For example, a subset of the non-users may be selected as recipients of network invitations based on the prior probabilities of the non-users. As described in more detail below with respect to FIG. 3, a Bernoulli distribution may be used to select the subset, or another technique by which some non-users with high prior probabilities and some non-users with low prior probabilities are selected for inclusion in the subset. This may ensure that the learning potential of the interactive feedback loop is not unduly skewed by potentially inaccurate prior probability values. However, generally speaking, non-users with higher prior probabilities may be more likely to be selected for inclusion in the subset than non-users with lower prior probabilities.

Invitations may be sent to all non-users in the subset, and responses to the invitations may be received. For example, some invited non-users may accept invitations, while others may decline or ignore invitations. These responses may be used to generate “posterior probabilities” (e.g., probabilities confirmed by ground truth), which may be either yes (e.g., 1) or no (e.g., 0). For example, if a respective non-user accepts an invitation to join the network, the posterior probability for the respective non-user may be set to 1. Conversely, if the respective non-user rejects (or, in some embodiments, ignores for a given length of time) an invitation to join the network, the posterior probability for the respective non-user may be set to 0. These are included as examples, and other techniques for determining posterior probabilities may be used.

The posterior probabilities may be then be used to update the prior probabilities of each non-user that was invited to join the network (e.g., each non-user in the subset). Furthermore, the prior probabilities of other non-users (e.g., not in the subset) may also be updated based on the posterior probabilities of the non-users in the subset. In one example technique, after updating the prior probabilities for the non-users in the subset to be the posterior probabilities for these non-users, all of the non-users (e.g., in and out of the subset) may be divided into “buckets” based on prior probabilities. For example, the buckets may correspond to different prior probability ranges (e.g., 0-0.1, 0.1-0.2, . . . , 0.9-1). For each bucket a sample proportion of invites accepted may be determined, such as based on how many non-users in the bucket were sent invites, and how many of those invites were accepted. The sample proportion for the bucket may then be used to update the prior probabilities of all non-users in the bucket, such as by averaging the prior probability for the bucket with the sample proportion, and setting the prior probability of all non-users in the bucket to the determined average. It is noted that this is included as an example, and other techniques for updating prior probabilities of all non-users based on the posterior probabilities of invited non-users are possible.

Once the prior probabilities of the non-users are updated (e.g., based on posterior probabilities in the feedback loop), a different subset of non-users may be selected to be invited to the network based on the updated prior probabilities. This “explore and exploit” process may be continued in an ongoing feedback loop by which the prior probabilities of non-users are iteratively improved through an interactive machine learning process, and the selection of non-users for targeted invitations to join the network becomes increasingly accurate over time and produces improved results (e.g., an improved invitation acceptance rate and an increasing number of users joining the network).

Embodiments of the present disclosure constitute a technical improvement with respect to conventional techniques for automatically selecting non-users as recipients of invitations to join a network. For example, by clustering users into active users and passive users based on attributes related to engagement with functionality of a software application, techniques described herein allow non-users to be compared specifically with actively-engaged users in order to determine whether to invite the non-users to the network, rather than comparing non-users to all users regardless of activity level and potentially inviting non-users that are only similar to disengaged users and are therefore less likely to accept an invitation. Furthermore, by utilizing information about non-users that is available to an application as a result of connections between users and the non-users, such as electronic records of transactions between the users and the non-users, rather than only relying on publicly available information about non-users, techniques described herein allow for more accurate profiles of non-users to be generated, resulting in more accurate targeting of invitations to non-users.

Additionally, by generating vector representations of non-users and active users based on electronic data available about the non-users and active users, techniques described herein allow non-users to be efficiently compared to active users in order to determine similarity measures that can be used to select non-users to invite to the network. The selection of some non-users with a low amount of similarity to active users (e.g., using a Bernoulli distribution) for targeted invitations in an “explore and exploit” process, rather than only selecting non-users with a high amount of similarity to active users, allows techniques described herein to iteratively correct for any inaccuracies in computed probabilities that have not yet been confirmed by ground truth. In general, the exploration and exploitation feedback loop described herein allows the system to iteratively improve over time based on feedback from invitation recipients, thereby producing improved accuracy and performance as the feedback loop continues.

While some existing techniques may involve training a machine learning model based on labeled training data to predict non-users that are likely to accept network invitations, these techniques generally require the generation of large amounts of labeled training data to be effective, which is an expensive an inefficient process. Embodiments of the present disclosure overcome these challenges through a unique automated learning process that is based on insights available from electronic transaction records, involving an interactive “explore and exploit” feedback loop by which targeted invitations are iteratively improved over time without requiring the generation of large amounts of labeled training data.

### Example Computing Environment

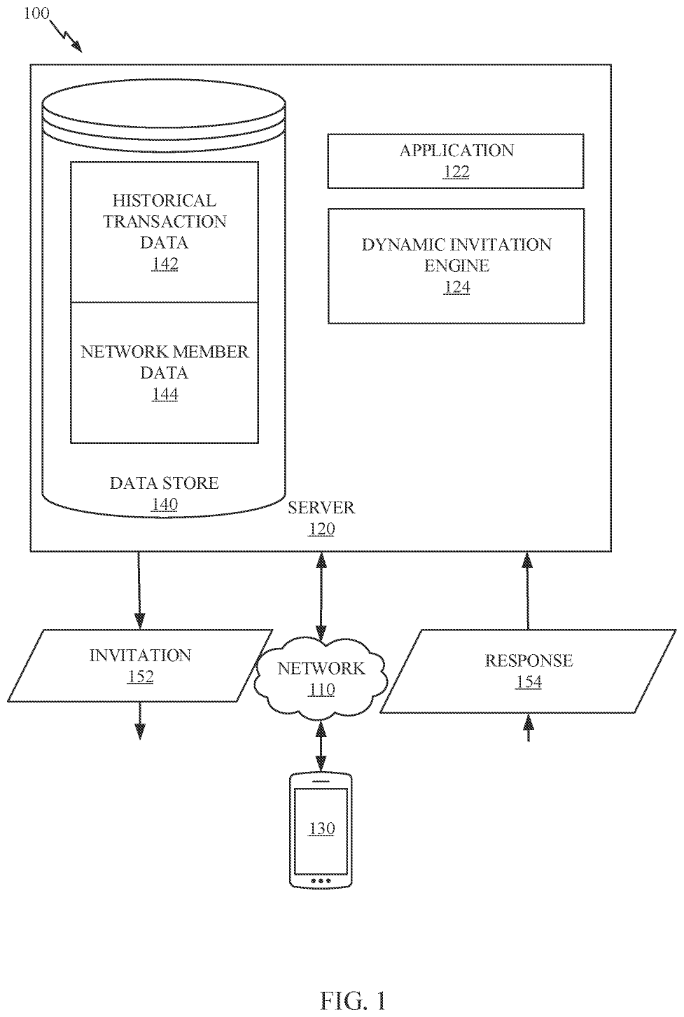

FIG. 1 illustrates an example computing environment 100 for dynamically targeting network invitations to entities outside of a network through an iterative feedback loop by which a system automatically learns and improves.

Computing environment 100 includes a server 120 and a client 130 connected over network 110. Network 110 may be representative of any type of connection over which data may be transmitted, such as a wide area network (WAN), local area network (LAN), cellular data network, and/or the like.

Server 120 includes an application 122, which generally represents a computing application that users interacts with over network 110, such as via computing devices (e.g., a user may interact with application 122 via client 130). In some embodiments, application 122 is accessed via a user interface associated with client 130.

According to one embodiment, application 122 is an electronic financial accounting system that assists users in book-keeping or other financial accounting practices. Additionally, or alternatively, the financial management system can manage one or more of tax return preparation, banking, investments, loans, credit cards, real estate investments, retirement planning, bill pay, and budgeting. In other embodiments, application 122 provides other, non-financial functionality, and involves interactions (e.g., which may be referred to as transactions) among users and non- users that do not necessarily relate to finances. Application 122 can be a standalone system, or can be integrated with other software or service products provided by a service provider.

In one embodiment, application 122 has a plurality of users that form a “network” of users. For example, all users of application 122 may be considered to be part of the user network of application 122.

Data store 140 generally represents a data storage entity such as a database or repository that stores historical transaction data 142 and network member data 144. Historical transaction data 142 generally includes electronic records of transactions carried out with the involvement or knowledge of application 122. For example, historical transaction data 142 may include records of transactions between users and other users as well as transactions between users and non-users of application 122. A transaction may include any type of interaction between two entities. For example, in the context financial management software, transactions may include sending and receiving invoices, sending and receiving payments, proposals and approvals of contractual terms, and/or the like. In other contexts, transactions may include social interactions such as sending and receiving messages, posting and sharing content, and/or the like. Network member data 144 may include information about network members (e.g., users of application 122), such as indicating attributes of users (e.g., business type, occupation, length of use of the application, level of membership, and/or the like), records of users' interactions with application 122 (e.g., indicating the types of functionality of application 122 that users utilize and how often such functionality is utilized), and/or the like.

A dynamic invitation engine 124 generally provides functionality related to dynamically targeting network invitations to entities outside of the network through an interactive feedback loop as described herein. For example, as described in more detail below with respect to FIG. 2, dynamic invitation engine 124 may use network member data 144 and/or historical transaction data 142 to cluster users of application 122 into an active user cluster and a passive user cluster. Dynamic invitation engine 124 may then generate profiles of all users in the active user cluster, and may also generate profiles of all non-users that have interacted with users (e.g., as indicated in historical transaction data 142). The profile of a given user or non-user may be a vector that is generated based on all connections between the given user or non-user and other users. Profile generation is described in more detail below with respect to FIG. 2. Dynamic invitation engine 124 may then determine a measure of similarity between the profile of each respective non-user and the users in the active user cluster, such as based on calculating a cosine similarity between the respective non-user's profile and a center point of the profiles of all users in the active user cluster. The similarity measure for each non-user may be used as a “prior probability” for that non-user (e.g., representing a probability of the non-user accepting a network invitation that has not yet been confirmed through ground truth data), as described in more detail below with respect to FIGS. 2 and 3.

Once prior probabilities for all non-users have been determined, the prior probabilities may be used to select a subset of the non-users as recipients of targeted invitations to join the network. As described in more detail below with respect to FIG. 3, the targeted invitations may be sent to the selected subset of non-users, and responses to the invitations may be used to update prior probabilities of some or all non-users for use in selecting a subsequent subset of non-users as recipients of targeted invitations to join the network, in a feedback loop by which the system incrementally learns improved probability values for increased accuracy and efficiency of invitation targeting.

For example, if a non-user associated with client 130 is selected as part of the subset of non-users, an invitation 152 is sent to the non-user via client 130, such as over network 110. A response 154 may be sent from client 130 to server 120, such as over network 110, and may indicate acceptance or rejection of invitation 152 by the non-user. In some embodiments, the absence of a response 154 to invitation 152 (e.g., for more than a threshold amount of time) is treated as an ignoring or rejection of invitation 152.

Response 154 (or, in some embodiments, a lack thereof) may be used to determine a posterior probability for the non-user (e.g., 0 for rejection or ignoring and 1 for acceptance), and the prior probability for the user may then be updated to match the posterior probability (e.g., since the actual outcome of inviting the non-user is now known). The same may be done for all non-users in the subset. Furthermore, prior probabilities of other non-users not in the subset may also be updated based on the posterior probabilities of the non-users in the subset, as described in more detail below with respect to FIG. 3.

The updated prior probabilities may then be used to select a different subset of non-users, and targeted invitations may be sent to the non-users on the different subset in order to continue the “explore and exploit” feedback loop described herein. As the process continues, the targeted invitations may become increasingly accurate and efficient, and the network of users may continue to grow with minimal utilization of physical computing resources in connection with generating, sending, receiving, and processing responses to network invitations (e.g., compared to prior techniques, which generally involve sending invitations to large numbers of non-users that are unlikely to accept the invitations and/or require generating large amounts of labeled training data in an expensive and inefficient process). Furthermore, the users may be periodically re-clustered into an active user cluster and a passive user cluster as new data about use of application 122 by the users becomes available (e.g., when a threshold amount of new data since the last clustering becomes available, when a threshold amount of time has passed since the last clustering, and/or the like), and the updated clusters may be used in subsequent iterations of the feedback loop described herein.

It is noted that functionality described with respect to server 120 and/or client 130 may alternatively or additionally be performed on one or more additional computing devices, such as in a distributed manner.

FIG. 2 is an illustration 200 of example aspects related to dynamically targeted network invitations. For example, illustration 200 may depict aspects of operations performed by dynamic invitation engine 124 of FIG. 1.

At network member clustering 210, entities that are members of a network (e.g., users of application 122 of FIG. 1) are clustered into a first cluster 212 representing passive users and a second cluster 214 representing active users. A variety of clustering techniques may be used to generate clusters 212 and 214, such as such as k-means clustering, k-elbow clustering, and/or any number of other suitable clustering techniques and/or models. For example, network member clustering 210 may be an unsupervised clustering process by which users are clustered based on various attributes related to use of network functionality by the users. Attributes used in network member clustering 210 may include, for example, number of connections between users and other users and/or non-users, number of requests sent (e.g., requests to perform various operations, such as requests to engage in a transaction or otherwise establish a connection), numbers of approved requests (e.g., numbers of requests that were accepted or approved by the recipients of such requests), numbers of received requests (e.g., from other users), numbers of bills sent within the network, numbers of invoices converted into bills, and/or the like. It is noted that these attributes are included as examples, and other types of attributes may be used, such as attributes relating to how frequently users have engaged with particular types of functionality provided by the application. In one example, an engagement vector is generated for each user based on the user's attributes related to use of the application, such as a vector where each dimension corresponds to a different attribute related to use of the application, and the engagement vector represents an extent to which the user has actively engaged with functionality provided by the network. A clustering technique may then be performed on the engagement vectors in order to generate clusters 212 and 214. Cluster 212 generally represents users whose attribute values indicate that the users have not engaged with network functionality or have only engaged with such functionality infrequently. Cluster 214 generally represents users whose attribute values indicate that the users have extensively engaged with network functionality. Cluster 214 includes, for example, a user 216, which may be associated with data indicating extensive use of network functionality (e.g., a larger number of connections, a larger number of requests sent, a larger number of requests approved, a larger number of requests received, a larger number of bills sent within the network, a larger number of invoices converted into bills, and/or other attribute values indicating active engagement with functionality provided by the application). Cluster 212 includes, for example, a user 213, which may be associated with data indicating minimal or no use of network functionality (e.g., a smaller number of connections, a smaller number of requests sent, a smaller number of requests approved, a smaller number of requests received, a smaller number of bills sent within the network, a smaller number of invoices converted into bills, and/or other attribute values indicating little to no active engagement with functionality provided by the application).

At profile generation 220, profiles are generated for all users in cluster 214 of active users and also for all non-users that are connected to one or more users. For example, for user 216 from cluster 214, all connections 222 between user 216 and other users and/or non-users (e.g., entities 224, 226, 228, and 229) are identified. For example, each connection 222 corresponds to one or more transactions between user 216 and another user or non-user. A vector is generated for each connection 222, such as including features of the connection 222. Features (f1, f2, f3, . . . ) included in a vector of a connection 222 may include, for example, a number of interactions (e.g., payments or other transactions) associated with the connection, amounts of transactions associated with the connection (e.g., amounts of money paid between the connected entities), frequency of interactions via the connection, whether certain application features are enabled for the connection (e.g., automatic payment configuration, stored payment methods, whether the user or non-user “follows” or “subscribes” to another user or non-user to which the user or non-user is connected via the connection), and/or the like.

The vectors for connections 222 of user 216 are used to generate a profile embedding 230 of user 216. For example, the vectors for connections 222 of user 216 may be aggregated to produce profile embedding 230, which may be a vector of features (f1, f2, f3, . . . ) of user 216. For example, the vectors for connections 222 may be averaged across all dimensions to produce profile embedding 230. An average is included as an example, and other aggregation techniques may also be used. For example, a min, max, median, sum, or other aggregation of the vectors for connections 222 across each dimension may be performed in order to produce profile embedding 230. Profile embedding 230 may alternative be referred to as a profile, a vector, and/or the like. An embedding generally refers to a vector that represents an entity in an n-dimensional space. For example, the vectors for connections 222 may also be referred to as connection embeddings.

A similar process to that depicted and described for generating profile embedding 230 for user 216 may be used to generate profile embeddings for the other users in cluster 214 as well as for the non-users that are connected to users.

At similarity calculation 230, a similarity is determined for each non-user (e.g., out-of-network entity that is connected to one or more users) with respect to the users in cluster 214, such as representing a degree of similarity between the non-user and active users. For example, the profile embeddings of the users in cluster 214 may be used to determine a vector to which each non-user's profile embedding (e.g., including non-user's profile embedding 236) can be compared. In one example a center point 234 of a cluster 232 of the profile embeddings of the users in cluster 214 is determined. Cluster 232 may, for example, include all of the profile embeddings of the users in cluster 214. Center point 234 may, for example, be a vector that represents a center point of cluster 232. In an example, a similarity between non-user's profile embedding 236 and center point 234 is determined, such as using cosine similarity or another measure of similarity between two vectors. A center point is included as an example, and other techniques of comparing a non-user's profile embedding to the profile embeddings of the users in cluster 214 may be used, such as comparing the non-user's profile embedding to a closest profile embedding in cluster 232 to the non-user's profile embedding in n-dimensional space, to each of the profile embeddings in cluster 232, and/or the like.

As described in more detail below with respect to FIG. 3, the similarity of each non-user's profile embedding to the profile embeddings of the users in cluster 214 (e.g., such as similarity 238 for non-user's profile embedding 236) may be used as a “prior probability” for the non-user, such as indicating a likelihood of the non-user to accept an invitation to join the network.

FIG. 3 is an illustration 300 of additional example aspects related to dynamically targeted network invitations. For example, illustration 300 may depict additional aspects of operations performed by dynamic invitation engine 124 of FIG. 1, and may continue from aspects described above with respect to FIG. 2.

At explore/exploit 310, the prior probabilities 312 of non-users are used to select a subset of the non-users as recipients of invitations to join the network. Prior probabilities 312 (e.g., p₁, p₂, p₃, . . . pₖ) may be determined as described above with respect to FIG. 2, such as by determining similarities between each of non users 1−k and users in an active user cluster (e.g., similarity 238 of FIG. 2). Each of prior probabilities 312 may initially be set to the similarity measure between a given non-user's profile embedding and a vector determined based on the profile embeddings of the users in the active user cluster (e.g., center point 234 of FIG. 2).

In some embodiments, the subset of non-users is selected based on which non-users have the highest prior probabilities. For example, the subset may include x non-users that have the highest prior probabilities. In other examples, the subset may include some non-users with lower prior probability values, such as to prevent the system's iterative learning from being unduly hampered by potentially inaccurate prior probability values. One example technique for ensuring such a mix of higher and lower prior probability values is included in the subset is the use of a Bernoulli distribution. For example, Bernoulli values 314 may be determined for the non-users based on the prior probabilities 312 for the non-users. Computing the Bernoulli value bi for non-user i based on the prior probability pᵢ for the non-user i may be represented as computing the function Ber(pᵢ), which results in a value of 0 or 1 for the Bernoulli value bᵢ. Thus, Bernoulli values 314 include values b₁, b₂, b₃, . . . bₖ, which represent a distribution of zeros and ones such that most of the 1 values represent non-users with higher prior probabilities (e.g., the highest of prior probabilities 312) but some of the 1 values represent non-users with lower prior probability values (e.g., the lowest of prior probabilities 312 or otherwise not the highest of prior probabilities 312). A Bernoulli distribution is a discrete probability distribution for events that have one trial and two possible outcomes, and is generally a type of binomial distribution that is known in the art. Generally, a Bernoulli distribution will include some success indications for events that are unlikely to be successful because, according to the laws of probability, even unlikely events sometimes occur. Thus, Bernoulli values 314 are likely to include mostly 1 values for non-users with high prior probabilities 312 and 0 values for non-users with low prior probability values 312, however, Bernoulli values 314 may also include 1 values for one or more non-users with low prior probability values 312 and may also include 0 values for one or more non-users with high prior probability values 312.

Once Bernoulli values 314 have been determined, a subset of x non-users is sampled from all of the non-users based on Bernoulli values 314. For example, x values may be sampled from bᵢ=1 (e.g., the set of Bernoulli values 314 that are equal to 1).

Once the subset of non-users has been selected, invitations to join the network are sent to all of the non-users in the subset. At feedback and probability updating 320, prior probability values of non-users are updated based on posterior probability values determined from feedback with respect to the invitations. For example, if a non-user accepts an invitation, the posterior probability for that non-user may be 1. If the non-user rejects the invitation, the posterior probability for that non-user may be 0. If the non-user ignores the invitation (e.g., for a threshold amount of time), the posterior probability for that non-user may be 0 (or some other value, such as 0.5). Generally, posterior probabilities represent ground truth values that indicate whether invitations were in fact accepted or rejected/ignored.

The prior probability of each respective non-user from which feedback has been received is updated to match the posterior probability for that respective non-user. Furthermore, the prior probabilities of other non-users (e.g., not included in the subset to which invitations were sent) may also be updated based on the posterior probabilities of the non-users from which feedback was received. In one example, after the prior probability of each respective non-user from which feedback has been received is updated to match the posterior probability for that respective non-user, the prior probabilities of all non-users are divided into buckets corresponding to particular prior probability ranges. For instance, a first bucket may include all non-users having a prior probability of 0-0.1, a second bucket may include all non-users having a prior probability of 0.1-0.2, a third bucket may include all non-users having a prior probability of 0.2-0.3, and so on (e.g., up to a last bucket, such as a tenth bucket, that includes all non-users having a prior probability of 0.9-1). For each bucket, prior probabilities of all non-users in the bucket may be updated to a new prior probability value that is determined based on a percentage or proportion of non-users in the bucket that were sent invitations that accepted the invitations. In an example, 200 non-users are included in the bucket of non-users having prior probabilities between 0.9 and 1, 10 of those non-users in the bucket were sent invitations, and 5 of those non-users accepted the invitations. Thus, the sample proportion of invites accepted for the bucket is 5/10 or 0.5. Thus, the prior probability of all 200 non-users in the bucket may be updated based on the sample proportion of invites accepted of 0.5, such as averaging the prior probability of each given non-user in the bucket with 0.5 to determine an updated prior probability for the given user, setting the prior probability of each given non-user in the bucket to 0.5, or otherwise updating the prior probability of each non-user in the bucket based on the sample proportion of invites accepted for the bucket. This technique is included as an example, and other techniques are possible. More generally, the prior probabilities of some or all non-users, including non-users not in the subset of non-users, may be updated based on the ground truth data determined from responses to the invitations sent to the subset of non-users.

A feedback loop 330 between explore/exploit 310 and feedback and probability updating 320 generally continues in such a manner as to allow prior probabilities 312 to be continually improved based on feedback with respect to invitations sent to each successively-selected subset of non-users, thus resulting in improved accuracy and efficiency over time. Furthermore, the initial clustering of users into active users and passive users may be updated over time, such as certain intervals, to ensure that these clusters are kept up to date as new data about use of the network by network members becomes available, including data about new network members joining as a result of invitations sent through the interactive feedback loop described herein.

### Example Operations Related to Dynamically Targeted Network Invitations

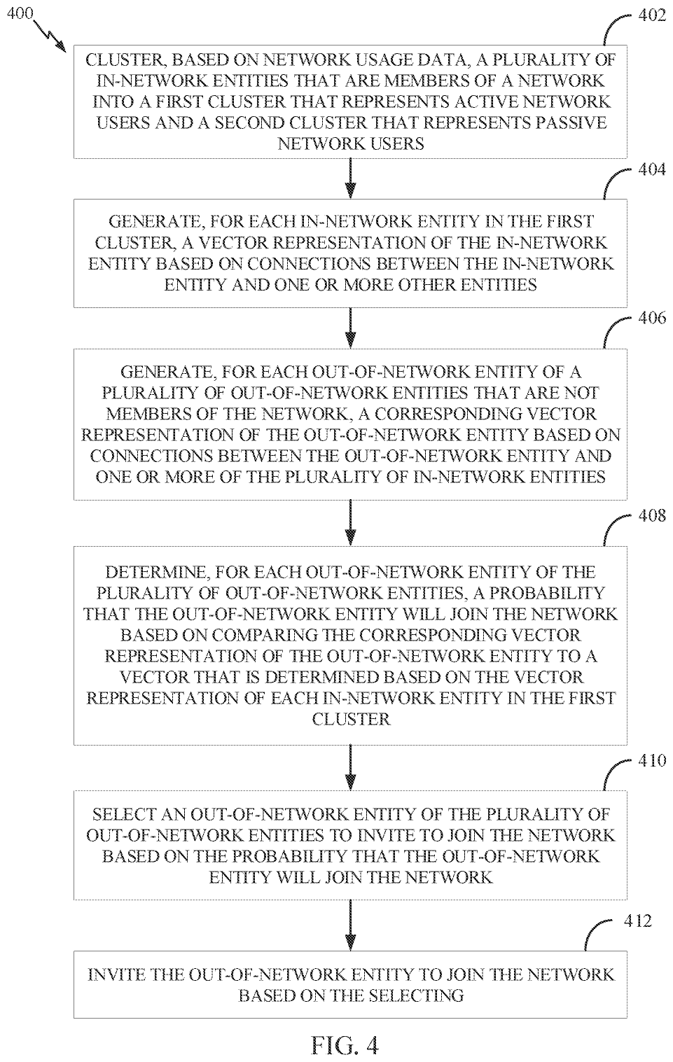

FIG. 4 depicts example operations 400 related to dynamically targeted network invitations. For example, operations 400 may be performed by one or more components of server 120 and/or client 130 of FIG. 1.

Operations 400 begin at step 402, with clustering, based on network usage data, a plurality of in-network entities that are members of a network into a first cluster that represents active network users and a second cluster that represents passive network users.

In some embodiments, the clustering is based on one or more of: numbers of connections as indicated in the network usage data; numbers of requests sent as indicated in the network usage data; numbers of requests received as indicated in the network usage data; numbers of requests approved as indicated in the network usage data; numbers of bills sent as indicated in the network usage data; or numbers of invoices converted into bills as indicated in the network usage data.

Operations 400 continue at step 404, with generating, for each in-network entity in the first cluster, a vector representation of the in-network entity based on connections between the in-network entity and one or more other entities.

In some embodiments, the generating of the vector representation for each in-network entity in the first cluster is based on one or more of: a number of transactions associated with each connection of the in-network entity; an amount of transactions associated with each connection of the in-network entity; a frequency of transactions associated with each connection of the in- network entity; or a payment configuration of the in-network entity.

Operations 400 continue at step 406, with generating, for each out-of-network entity of a plurality of out-of-network entities that are not members of the network, a corresponding vector representation of the out-of-network entity based on connections between the out-of-network entity and one or more of the plurality of in-network entities.

Operations 400 continue at step 408, with determining, for each out-of-network entity of the plurality of out-of-network entities, a probability that the out-of-network entity will join the network based on comparing the corresponding vector representation of the out-of-network entity to a vector that is determined based on the vector representation of each in-network entity in the first cluster. In certain embodiments, the vector is determined by calculating a central point of a cluster comprising the vector representation of each in-network entity in the first cluster.

Operations 400 continue at step 410, with selecting an out-of-network entity of the plurality of out-of-network entities to invite to join the network based on the probability that the out-of-network entity will join the network.

In some embodiments, the selecting of the out-of-network entity is based on calculating a Bernoulli distribution of the plurality of out-of-network entities using the probability that each out-of-network entity of the plurality of out-of-network entities will join the network.

Operations 400 continue at step 412, with inviting the out-of-network entity to join the network based on the selecting.

Certain embodiments further comprise receiving feedback from the out-of-network entity in response to the inviting, updating, based on the feedback, the probability that the out-of-network entity will join the network, recalculating, based on the updated probability that the out-of-network entity will join the network, the probability that each of one or more other out-of-network entities of the plurality of out-of-network entities will join the network, and selecting an additional out-of-network entity of the plurality of out-of-network entities to invite to join the network based on the recalculated probability that each of the one or more other out-of-network entities will join the network.

In some embodiments, the recalculating comprises dividing the plurality of out-of-network entities into buckets based on the probability that each out-of-network entity of the plurality of out-of-network entities will join the network and, for each bucket of the buckets, updating probabilities of all out-of-network entities in the bucket based on an invitation acceptance rate for the bucket that is determined using the feedback.

Certain embodiments further comprise performing an updated clustering to generate an updated first cluster and an updated second cluster based on updated network usage data.

### Example Computing System

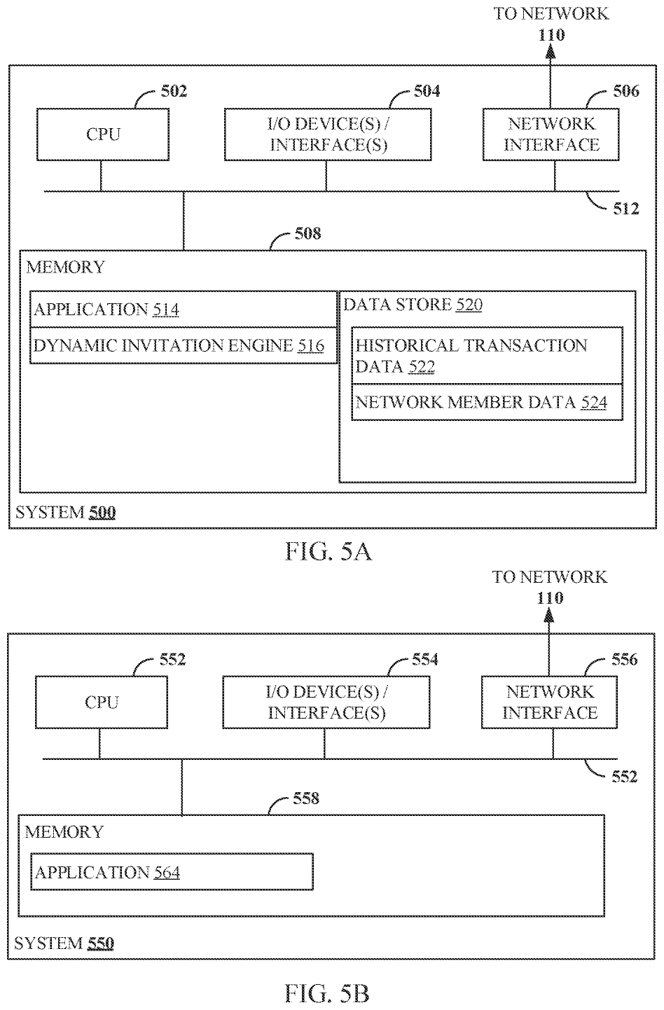

FIG. 5A illustrates an example system 500 with which embodiments of the present disclosure may be implemented. For example, system 500 may be representative of server 120 of FIG. 1.

System 500 includes a central processing unit (CPU) 502, one or more I/O device interfaces 504 that may allow for the connection of various I/O devices 514 (e.g., keyboards, displays, mouse devices, pen input, etc.) to the system 500, network interface 506, a memory 508, and an interconnect 512. It is contemplated that one or more components of system 500 may be located remotely and accessed via a network. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes application 514 and dynamic invitation engine 516, which may be representative of application 122 and dynamic invitation engine 124 of FIG. 1. Memory 508 further comprises data store 520, which may be representative of data store 140 of FIG. 1. While data store 520 is depicted in local storage of system 500, it is noted that data store 520 may also be located remotely (e.g., at a location accessible over a network, such as the Internet). Data store 520 includes historical transaction data 522 and network member data 524, which may be representative of historical transaction data 142 and network member data 144 of FIG. 1.

FIG. 5B illustrates another example system 550 with which embodiments of the present disclosure may be implemented. For example, system 550 may be representative of client 130 of FIG. 1.

System 550 includes a central processing unit (CPU) 552, one or more I/O device interfaces 554 that may allow for the connection of various I/O devices 554 (e.g., keyboards, displays, mouse devices, pen input, etc.) to the system 550, network interface 556, a memory 558, and an interconnect 552. It is contemplated that one or more components of system 550 may be located remotely and accessed via a network. It is further contemplated that one or more components of system 550 may comprise physical components or virtualized components.

CPU 552 may retrieve and execute programming instructions stored in the memory 558. Similarly, the CPU 552 may retrieve and store application data residing in the memory 558. The interconnect 552 transmits programming instructions and application data, among the CPU 552, I/O device interface 554, network interface 556, and memory 658. CPU 552 is included to be representative of a single CPU, multiple CPUs, a single CPU having multiple processing cores, and other arrangements.

Additionally, the memory 558 is included to be representative of a random access memory. In some embodiments, memory 558 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 558 includes an application 564, which may be representative of a client-side component corresponding to the server-side application 514 of FIG. 5A. For example, application 564 may comprise a user interface through which a user of system 550 interacts with application 514 of FIG. 5A. In alternative embodiments, application 514 is a standalone application that performs behavior prediction as described herein.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for dynamic targeting of network invitations, comprising:
clustering, based on network usage data, a plurality of in-network entities that are members of a network into a first cluster that represents active network users and a second cluster that represents passive network users;
generating, for each in-network entity in the first cluster, a vector representation of the in-network entity based on connections between the in-network entity and one or more other entities;
generating, for each out-of-network entity of a plurality of out-of-network entities that are not members of the network, a corresponding vector representation of the out-of-network entity based on connections between the out-of-network entity and one or more of the plurality of in-network entities;
determining, for each out-of-network entity of the plurality of out-of-network entities, a probability that the out-of-network entity will join the network based on comparing the corresponding vector representation of the out-of-network entity to a vector that is determined based on the vector representation of each in-network entity in the first cluster;
selecting an out-of-network entity of the plurality of out-of-network entities to invite to join the network based on the probability that the out-of-network entity will join the network; and
inviting the out-of-network entity to join the network based on the selecting.

2. The method of claim 1, further comprising:
receiving feedback from the out-of-network entity in response to the inviting;
updating, based on the feedback, the probability that the out-of-network entity will join the network;
recalculating, based on the updated probability that the out-of-network entity will join the network, the probability that each of one or more other out-of-network entities of the plurality of out-of-network entities will join the network; and
selecting an additional out-of-network entity of the plurality of out-of-network entities to invite to join the network based on the recalculated probability that each of the one or more other out-of-network entities will join the network.

3. The method of claim 2, wherein the recalculating comprises:
dividing the plurality of out-of-network entities into buckets based on the probability that each out-of-network entity of the plurality of out-of-network entities will join the network; and
for each bucket of the buckets, updating probabilities of all out-of-network entities in the bucket based on an invitation acceptance rate for the bucket that is determined using the feedback.

4. The method of claim 2, further comprising performing an updated clustering to generate an updated first cluster and an updated second cluster based on updated network usage data.

5. The method of claim 1, wherein the selecting of the out-of-network entity is based on calculating a Bernoulli distribution of the plurality of out-of-network entities using the probability that each out-of-network entity of the plurality of out-of-network entities will join the network.

6. The method of claim 1, wherein the vector is determined by calculating a central point of a cluster comprising the vector representation of each in-network entity in the first cluster.

7. The method of claim 1, wherein the clustering is based on one or more of:
numbers of connections as indicated in the network usage data;
numbers of requests sent as indicated in the network usage data;
numbers of requests received as indicated in the network usage data;
numbers of requests approved as indicated in the network usage data;
numbers of bills sent as indicated in the network usage data; or
numbers of invoices converted into bills as indicated in the network usage data.

8. The method of claim 1, wherein the generating of the vector representation for each in-network entity in the first cluster is based on one or more of:
a number of transactions associated with each connection of the in-network entity;
an amount of transactions associated with each connection of the in-network entity;
a frequency of transactions associated with each connection of the in-network entity; or
a payment configuration of the in-network entity.

9. A system for dynamic targeting of network invitations, comprising:
one or more processors; and
a memory comprising instructions that, when executed by the one or more processors, cause the system to:
cluster, based on network usage data, a plurality of in-network entities that are members of a network into a first cluster that represents active network users and a second cluster that represents passive network users;
generate, for each in-network entity in the first cluster, a vector representation of the in-network entity based on connections between the in-network entity and one or more other entities;
generate, for each out-of-network entity of a plurality of out-of-network entities that are not members of the network, a corresponding vector representation of the out-of-network entity based on connections between the out-of-network entity and one or more of the plurality of in-network entities;
determine, for each out-of-network entity of the plurality of out-of-network entities, a probability that the out-of-network entity will join the network based on comparing the corresponding vector representation of the out-of-network entity to a vector that is determined based on the vector representation of each in-network entity in the first cluster;
select an out-of-network entity of the plurality of out-of-network entities to invite to join the network based on the probability that the out-of-network entity will join the network; and
invite the out-of-network entity to join the network based on the selecting.

10. The system of claim 9, wherein the instructions, when executed by the one or more processors, further cause the system to:
receive feedback from the out-of-network entity in response to the inviting;
update, based on the feedback, the probability that the out-of-network entity will join the network;
recalculate, based on the updated probability that the out-of-network entity will join the network, the probability that each of one or more other out-of-network entities of the plurality of out-of-network entities will join the network; and
select an additional out-of-network entity of the plurality of out-of-network entities to invite to join the network based on the recalculated probability that each of the one or more other out-of-network entities will join the network.

11. The system of claim 10, wherein the recalculating comprises:
dividing the plurality of out-of-network entities into buckets based on the probability that each out-of-network entity of the plurality of out-of-network entities will join the network; and
for each bucket of the buckets, updating probabilities of all out-of-network entities in the bucket based on an invitation acceptance rate for the bucket that is determined using the feedback.

12. The system of claim 10, wherein the instructions, when executed by the one or more processors, further cause the system to perform an updated clustering to generate an updated first cluster and an updated second cluster based on updated network usage data.

13. The system of claim 9, wherein the selecting of the out-of-network entity is based on calculating a Bernoulli distribution of the plurality of out-of-network entities using the probability that each out-of-network entity of the plurality of out-of-network entities will join the network.

9. system of claim 9, wherein the vector is determined by calculating a central point of a cluster comprising the vector representation of each in-network entity in the first cluster.

15. The system of claim 9, wherein the clustering is based on one or more of:
numbers of connections as indicated in the network usage data;
numbers of requests sent as indicated in the network usage data;
numbers of requests received as indicated in the network usage data;
numbers of requests approved as indicated in the network usage data;
numbers of bills sent as indicated in the network usage data; or
numbers of invoices converted into bills as indicated in the network usage data.

16. The system of claim 9, wherein the generating of the vector representation for each in-network entity in the first cluster is based on one or more of:
a number of transactions associated with each connection of the in-network entity;
an amount of transactions associated with each connection of the in-network entity;
a frequency of transactions associated with each connection of the in-network entity; or
a payment configuration of the in-network entity.

17. A non-transitory computer-readable medium comprising instructions that, when executed by one or more processors of a computing system, cause the computing system to:
cluster, based on network usage data, a plurality of in-network entities that are members of a network into a first cluster that represents active network users and a second cluster that represents passive network users;
generate, for each in-network entity in the first cluster, a vector representation of the in-network entity based on connections between the in-network entity and one or more other entities;
generate, for each out-of-network entity of a plurality of out-of-network entities that are not members of the network, a corresponding vector representation of the out-of-network entity based on connections between the out-of-network entity and one or more of the plurality of in-network entities;
determine, for each out-of-network entity of the plurality of out-of-network entities, a probability that the out-of-network entity will join the network based on comparing the corresponding vector representation of the out-of-network entity to a vector that is determined based on the vector representation of each in-network entity in the first cluster;
select an out-of-network entity of the plurality of out-of-network entities to invite to join the network based on the probability that the out-of-network entity will join the network; and
invite the out-of-network entity to join the network based on the selecting.

18. The non-transitory computer-readable medium of claim 17, wherein the instructions, when executed by the one or more processors, further cause the computing system to:
receive feedback from the out-of-network entity in response to the inviting;
update, based on the feedback, the probability that the out-of-network entity will join the network;
recalculate, based on the updated probability that the out-of-network entity will join the network, the probability that each of one or more other out-of-network entities of the plurality of out-of-network entities will join the network; and
select an additional out-of-network entity of the plurality of out-of-network entities to invite to join the network based on the recalculated probability that each of the one or more other out-of-network entities will join the network.

19. The non-transitory computer-readable medium of claim 18, wherein the recalculating comprises:
dividing the plurality of out-of-network entities into buckets based on the probability that each out-of-network entity of the plurality of out-of-network entities will join the network; and
for each bucket of the buckets, updating probabilities of all out-of-network entities in the bucket based on an invitation acceptance rate for the bucket that is determined using the feedback.

20. The non-transitory computer-readable medium of claim 18, wherein the instructions, when executed by the one or more processors, further cause the computing system to perform an updated clustering to generate an updated first cluster and an updated second cluster based on updated network usage data.
